(19) United States
(12) Patent Application Publication
(10) Pub. No.: US 2008/0094839 A1
(43) Pub. Date: Apr. 24, 2008

(54) Patterned ornament having lighting figures

(76) Inventor: Wun Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/583,823

(22) Filed: Oct. 20, 2006

(51) Int. Cl. F21V 19/02

(52) U.S. Cl. 362/285

(57) ABSTRACT

The invention relates to a patterned ornament having lighting figures, which includes a transparent shell and inner lighting means. The inner surface of the ornament is provided with specific inclined or curved planes to reflect light ray to form specific virtual image shown on the ornament. The patterned ornament thus obtains beautiful outlook and increases decorative effect.

### FIELD OF THE INVENTION

The present invention relates to a patterned ornament, which may have different lighting figures on surface to display specific decorative effect.

### BACKGROUND OF THE INVENTION

Most known ornaments are designed to have special patterns for various decorative purposes. They are visible only in daytime but in the night. Some improved decorations have transparent shell with inner lighting means to increase their decorative effect. But the simple lighting configuration is still monotonous.

### SUMMARY OF THE INVENTION

The present invention is to provide a patterned ornament, which may have different lighting figures shown on the surface of the ornament to provide a special beautiful decoration. Now, accompanying with the following drawings, the character of the present invention will be described here and after.

### BRIEF DESCRIPTION OF THE DRAWINGS

FIG. 1 is a perspective view showing an embodiment of a patterned ornament according to the present invention.

FIG. 2 is a plan view showing a part of surface of the patterned ornament of the present invention.

FIG. 3 is a cross-sectional plan view showing an example of light emitting related to the shell of the patterned ornament.

FIG. 4 is a cross-sectional plan view showing another example of light emitting related to the shell of the patterned ornament.

FIG. 5 is an enlarged plan view showing a structure of the shell of the patterned ornament according to the present invention.

### DETAILED DESCRIPTION OF THE PREFERRED EMBODIMENT

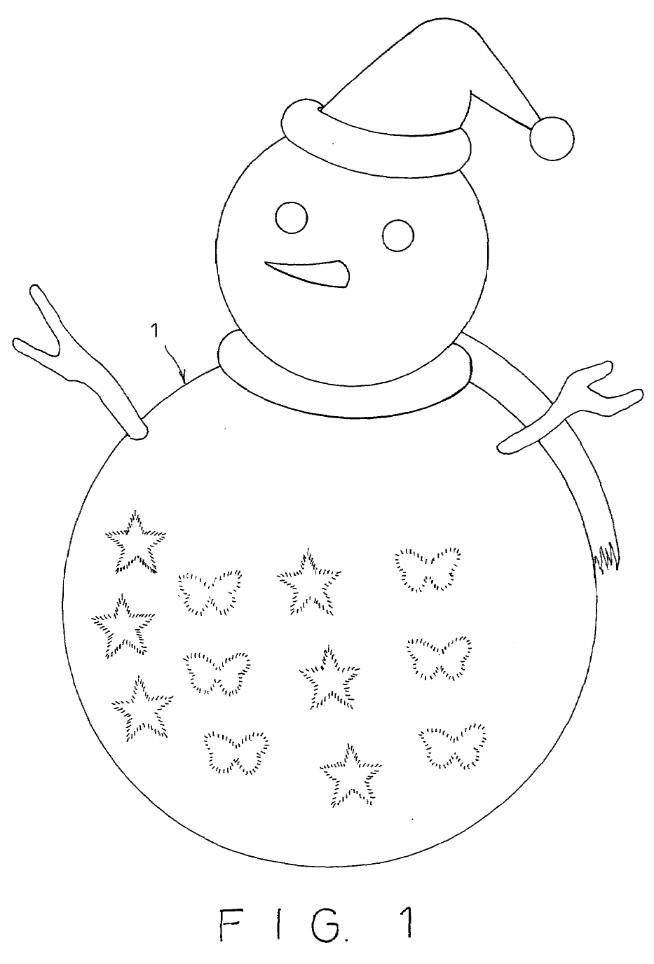

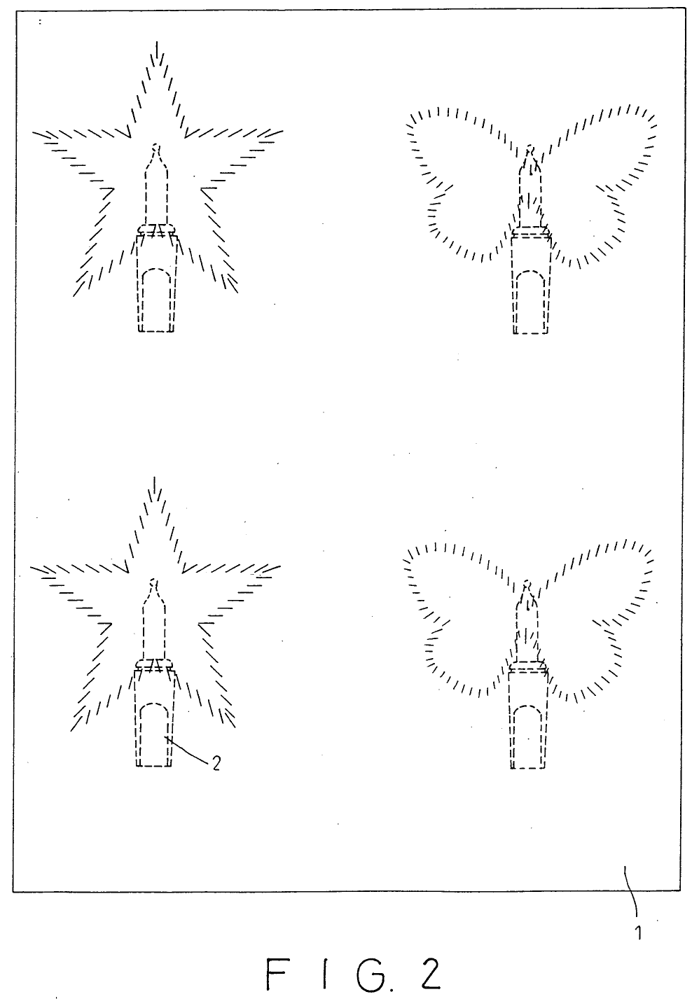

The present invention relates to a patterned ornament having lighting figures, for example, as illustrated in FIG. 1 and 2. The ornament (1) can be designed as a snowman, which has a transparent shell and an inner lighting means (2), in this embodiment, a bulb assembly. The lighting means (2) emits rays to form several special different lighting figures on the surface of the ornament (1), as shown the dot lines in the drawings.

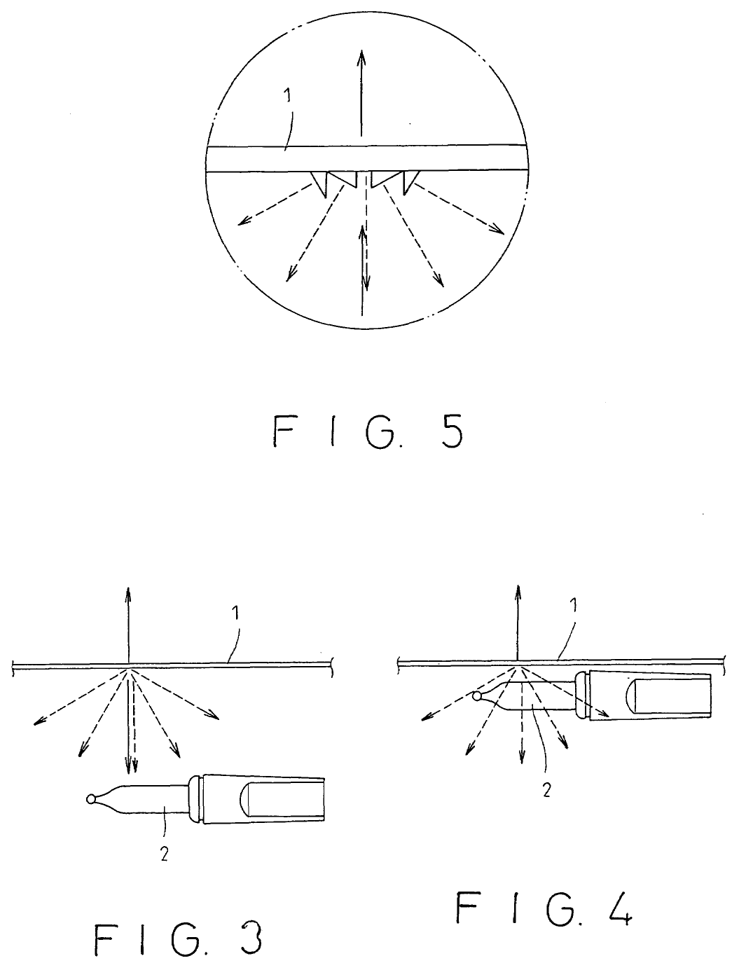

In order to obtain the lighting effect mentioned above, please refer to FIG. 3 to 5, wherein the distance between the lighting means (2) and the shell of the ornament (1) is adjustable. And the inner surface of the ornament (1) is formed with some specific inclined or curved planes. The lighting means (2) emits rays to the ornament (1). The ray can be reflected to form virtual images, which will be shown on the surface of the ornament (1). Different inclined or curved planes can form different virtual images. Hence, the patterned ornament present invention may have several various lighting figures on the surface and obtains improved decorative effect.

It can be understood that the above-mentioned structures are only embodiments to illustrate my designs and are not to limit the scope of this application. Any modified embodiment with similar merits, such as to use another patterned decoration or to design different inner plane for forming different virtual image, will be still claimed by the present invention.

I claim:

1. A patterned ornament having lighting figures including a transparent shell and inner lighting means, and the character in to provide the inner surface of the ornament with inclined or curved planes, which reflect light ray to form virtual images shown of the ornament.

2. The soft handle having a lighting apparatus as claimed in claim 1, wherein the distance between the lighting means and the ornament is adjustable.
